(19) United States
(12) Patent Application Publication
(10) Pub. No.: US 2022/0266328 A1
(43) Pub. Date: Aug. 25, 2022

(54) MACHINING OF STEEL AT ELEVATED SURFACE TEMPERATURES

(71) Applicant: MAGNA INTERNATIONAL INC., Aurora (CA)

(72) Inventors: Kyle Daniel FAIRBARN, Lefroy (CA); Leslie George SHUMAN, Smithville (CA)

(21) Appl. No.: 17/625,147

(22) PCT Filed: Jul. 7, 2020
(86) PCT No.: PCT/IB2020/056372

§ 371 Date: Jan. 6, 2022

Related U.S. Application Data
(60) Provisional application No. 62/873,291, filed on Jul. 12, 2019.

(51) Int. Cl. B21D 37/20; B23P 15/24

(52) U.S. Cl. CPC B21D 37/20; B23P 15/24

(57) ABSTRACT

A method for forming a die is provided. The method includes heating a die structure such that a surface thereof is at least 450° C.; and machining, by a machining system, a predetermined surface profile on the surface of the die structure while the temperature of the surface is the at least 450° C. to form the die.

### CROSS-REFERENCE TO RELATED APPLICATION(S)

This application claims the benefit of priority of U.S. Provisional Application No. 62/873,291, filed on Jul. 12, 2019.

### FIELD

The present patent application relates to a method and a system for forming a die. Specifically, a method and a system for machining Tailored Tempered Properties (TTP) form steel die structure at elevated temperatures.

### BACKGROUND

Vehicle manufacturers strive to provide vehicles that are increasingly stronger, lighter and less expensive. For example, vehicle manufacturers have expended significant efforts to utilize non-traditional materials, such as sheet aluminum, advanced high strength steels, and ultra-high strength steels, for portions of the vehicle body. While such materials may be both relatively strong and light, they are typically costly to purchase, form and/or assemble.

Hot forming generally comprises heating a blank in a furnace, followed by stamping the heated blank between a pair of dies to form a shaped part, and quenching the shaped part between the dies. The blank is generally heated in the furnace to achieve an austenitic microstructure, and then quenched in the dies to transform the austenitic microstructure to a martensitic microstructure. The known hot forming dies for performing the simultaneous hot forming and quenching procedures typically employ cooling passages (for circulating coolant through the hot forming die) that are formed in a conventional manner.

Also, when surface temperature and core temperature of Tailored Tempered Properties (TTP) form steel die structure are elevated, computing an expansion of the Tailored Tempered Properties (TTP) form steel die structure has been difficult.

The present patent application provides improvements to hot forming/stamping systems and/or methods.

### SUMMARY

One aspect of the present patent application provides a method for forming a die. The method includes heating a die structure such that a surface thereof is at least 450° C.; and machining, by a machining system, a predetermined surface profile on the surface of the die structure while the temperature of the surface is the at least 450° C. to form the die.

These and other aspects of the present patent application, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the present patent application, the structural components illustrated herein are drawn to scale. It is to be expressly understood, however, that the drawings are for the purpose of illustration and description only and are not intended as a definition of the limits of the present patent application. It shall also be appreciated that the features of one embodiment disclosed herein can be used in other embodiments disclosed herein. As used in the specification and in the claims, the singular form of “a”, “an”, and “the” include plural referents unless the context clearly dictates otherwise.

### BRIEF DESCRIPTION OF THE DRAWINGS

FIG. 1 shows a system for producing components by hot forming procedures in accordance with an embodiment of the present patent application;

FIG. 2 shows a Tailored Tempered Properties (TTP) form steel die structure of the hot forming system in accordance with an embodiment of the present patent application;

FIG. 3 shows a partial view of the TTP form steel die structure of the hot forming system in accordance with an embodiment of the present patent application;

FIG. 4 shows a system for forming the TTP form steel die structure of the hot forming system in accordance with an embodiment of the present patent application;

FIGS. 5-7 show side views of the TTP form steel die structure of the hot forming system in accordance with embodiments of the present patent application, wherein FIGS. 5-6 show a water coolant supply for the system and FIG. 7 shows a power supply for the system for forming the TTP form steel die structure in accordance with an embodiment of the present patent application;

FIG. 8 shows a side view of an exemplary tool used in the system for forming the TTP form steel die structure of the hot forming system in accordance with an embodiment of the present patent application;

FIG. 9 shows an exemplary system for forming the TTP form steel die structure of the hot forming system in accordance with an embodiment of the present patent application;

FIG. 10 shows an exemplary method for forming the TTP form steel die structure of the hot forming system in accordance with an embodiment of the present patent application; and

FIG. 11 shows a cross-sectional view of the TTP form steel die structure (shown in FIG. 2) of the hot forming system in accordance with an embodiment of the present patent application.

### DETAILED DESCRIPTION OF THE DRAWINGS

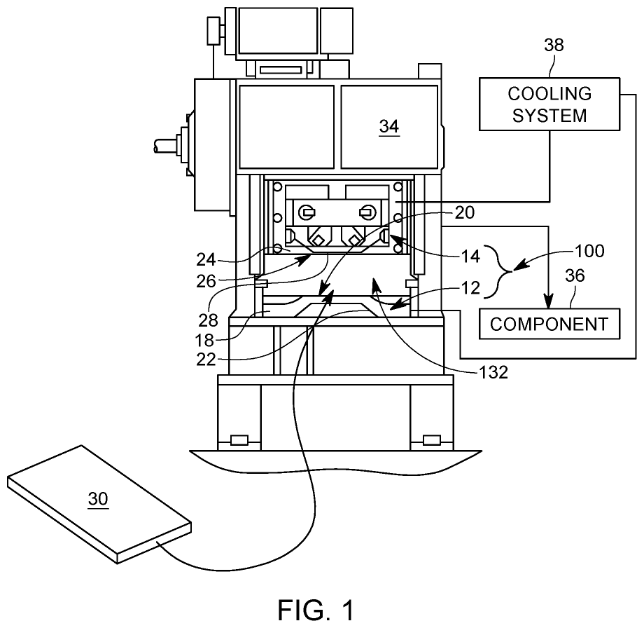

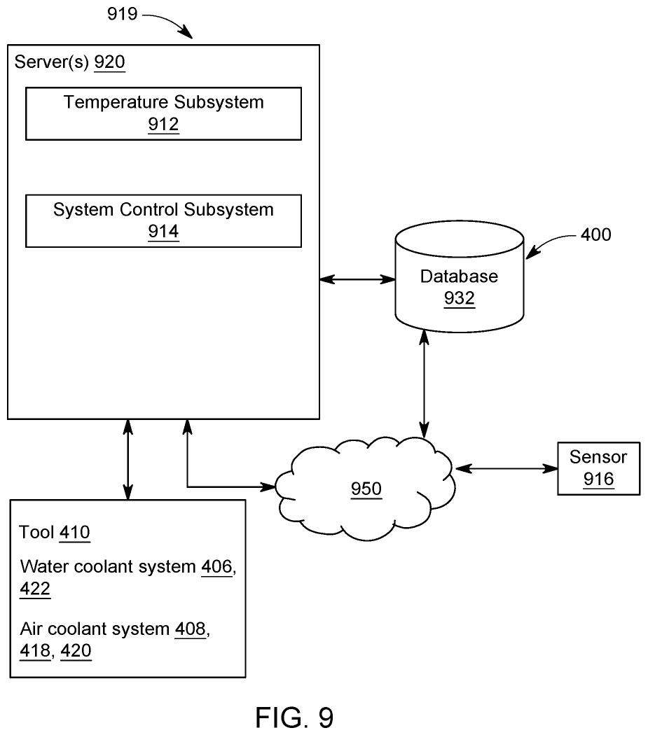

Referring to FIGS. 1-4 and 10-11, in one embodiment, a method 1000 for forming a die 12, 14 is provided. The method 1000 includes heating a die structure 432 such that a surface 430 thereof is at least 450° C.; and machining, by a machining system 400, a predetermined surface profile on the surface 430 of the die structure 432 while the temperature of the surface 430 is the at least 450° C. to form the die 12, 14. In one embodiment, the die structure 432 is a Tailored Tempered Properties (TTP) form steel die structure. In one embodiment, as shown in FIG. 9, the method 1000 is implemented by a computer system 919 that comprises one or more physical/hardware processors 920 executing computer program/machine readable instructions that, when executed, perform method 1000.

In one embodiment, during machining, the temperature of the surface 430 of the die structure 432 is maintained in the range between 450 and 500° C. In one embodiment, during machining, the temperature of the surface 430 of the die structure 432 is maintained at 450° C. In one embodiment, during machining, the temperature of the surface 430 of the die structure 432 is maintained in the range between 450 and 550° C. In one embodiment, during machining, the temperature of the surface 430 of the die structure 432 is maintained at 525° C.

In one embodiment, during machining, the temperature of the core of the die structure 432 is no more than 560° C. In one embodiment, during machining, the temperature of the core of the die structure 432 is maintained in the range between 500 and 650° C. In one embodiment, during machining, the temperature of the core of the die structure 432 is maintained in the range between 500 to 700° C. In one embodiment, the temperature range of the core of the die structure 432 is dependent upon the forming materials red hardness capabilities (i.e., the maximum temperature a material can withstand that will not cause the material to lose its initial hardness).

Referring to FIG. 1, in one embodiment, a hot forming system 100 is configured for producing components by hot forming or hot stamping. In one embodiment, hot forming generally comprises heating a blank/workpiece 30 in a furnace, followed by stamping/forming the heated blank between a pair of dies 12 and 14 to form a shaped part 36, and quenching the shaped part 36 between the dies 12 and 14. The blank 30 is generally heated in the furnace to achieve an austenitic microstructure, and then quenched in the dies 12 and 14 to transform the austenitic microstructure to a martensitic microstructure. In one embodiment, the system 100 comprises the first die 12 having a first die surface 20 and the second die 14 having a second die surface 26. The first and second die surfaces 20 and 26 are configured to cooperate to form a die cavity 132 therebetween so as to receive the work piece 30 therein and configured to be on opposite sides of the work piece 30 received in the die cavity 132 to form the hot stamped component 36.

In one embodiment, each die 12, 14 includes press hardened die structure and Tailored Tempered Properties (TTP) form steel die structure 432. That is, the press hardened die structure and the TTP form steel die structure 432 together form the die 12, 14.

In one embodiment, the press hardened die structure includes cooling channels 22, 28 to cool the press hardened die structure of the die 12, 14 during the hot forming procedures.

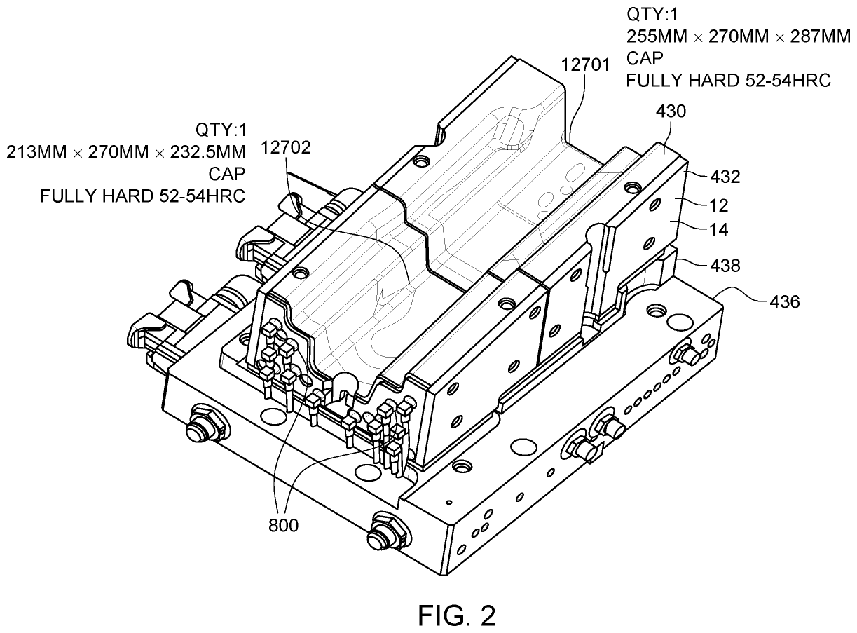

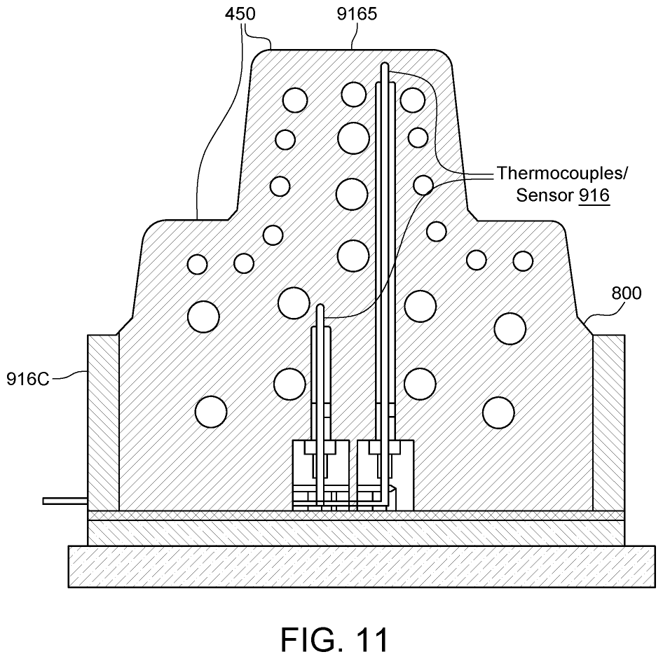

In one embodiment, the TTP form steel die structure 432 includes airlines 450 and heaters 800 (both discussed in detail below and shown in FIG. 11) that work together to regulate the temperature of the TTP form steel die structure 432. That is, the heaters 800 and the airlines 450 (or channels for air cooling) in the TTP form steel die structure 432 are configured to maintain their surface temperature range and/or their core temperature range. In one embodiment, unlike the press hardened die structure, the TTP form steel die structure 432 does not include cooling (e.g., water) channels. In one embodiment, the TTP form steel die structure 432 of the die 12, 14 are shown in FIGS. 2, 3 and 11. In one embodiment, the TTP form steel portions 432, shown in FIGS. 2, 3 and 11, form part of the upper die 14.

A blank 30, which can be formed of an appropriate heat-treatable steel, such as boron steel, can be pre-heated to a predetermined temperature, such as about 930° C., and can be placed in the die cavity 132 between the complex die surfaces 20 and 26. The first and second dies 12 and 14 can be brought together (i.e., closed) in a die action direction via a conventional stamping press 34 to deform the blank 30 so as to form and optionally trim a hot stamped component 36. Cooling fluid, such as water, gas or other coolant medium, which can be provided by a cooling system 38 (e.g., a cooling system that conventionally includes a reservoir/chiller and a fluid pump) can be continuously circulated through cooling channels 22 and 28 to cool the press hardened die structures of the first and second dies 12 and 14, respectively. It will be appreciated that the circulating cooling fluids will cool the press hardened die structures of the first and second dies 12 and 14 and that the first and second dies 12 and 14 will quench and cool the hot stamped component 36. The stamping press 34 can maintain the first and second dies 12 and 14 in a closed relationship for a predetermined amount of time to permit the hot stamped component 36 to be cooled to a desired temperature.

In one embodiment, the distance between the cooling channels 22 and 28 and the complex die surfaces 20 and 26, respectively, as well as the mass flow rate of the cooling fluid and the temperature of the cooling fluid are selected to control the cooling of both the press hardened die structures of the first and second dies 12 and 14 such that the hot stamped component 36 is quenched in a controlled manner consistently across its major surfaces to cause a phase transformation to a desired metallurgical state. In the particular example provided, the blank 30 is heated such that its structure is substantially (if not entirely) composed of austenite, the heated blank 30 is formed between the first and second dies 12 and 14 and the hot stamped component 36 is quenched by the first and second dies 12 and 14 prior to the ejection of the hot stamped component 36 from the first and second dies 12 and 14. In this regard, the press hardened portions of the first and second dies 12 and 14 function as a heat sink_to draw heat from and thereby quench the hot stamped component 36 in a controlled manner to cause a desired phase transformation (e.g., to martensite or to bainite) in the hot stamped component 36 and optionally to cool the hot stamped component 36 to a desired temperature. Thereafter, the first and second dies 12 and 14 can be separated from one another (i.e., opened) and the heat-treated hot stamped component 36 can be removed from the die cavity 132.

In one embodiment, portions of the hot stamped component 36 that are adjacent heater/heating structure (e.g., of the TTP form steel die structures 432) of the die 12, 14 during the forming procedures have high ductile properties and portions of the hot stamped component 36 that are adjacent water cooled (e.g., press hardened) die members of the die 12, 14 during the forming procedures have high tensile properties.

In one embodiment, the press hardened die structure of each of the first and second dies 12 and 14 includes a plurality of openings that are configured to receive the plurality of cooling channels 22 or 28 therethrough. In one embodiment, the plurality of cooling channels 22 or 28 are configured to cool the press hardened die structure of the corresponding die 12 or 14 in order to quench the hot stamped component 36 in the die cavity 132 in a controlled manner so as to cause a desired phase transformation in portions of the hot stamped component 36 or to cause a phase transformation of portions of the hot stamped component 36 to a desired metallurgical state. Construction of the hot forming system 100 in accordance with an embodiment of the present patent application permits the rate of quenching/cooling at each point on the die surface 20 or 26 to be controlled in a precise manner. This is particularly advantageous for high-volume production as it is possible to employ relatively short overall cycle times while achieving an austenite-to-martensite transformation.

The source of cooling fluid 38 (FIG. 1) and the design, placement and construction of the cooling channels 22 and 28 permit the first and second dies 12 and 14 to be cooled to an extent where they can quench the hot stamped component 36 (FIG. 1) relatively quickly, even when the hot forming system 100 is employed in volume production. In operation, pressurized fluid, preferably water, from the source of cooling fluid 38 (FIG. 1) is input through the cooling apertures 22 and 28. In one embodiment, the cooling fluid is cycled in a continuous, uninterrupted manner, but it will be appreciated that the flow of cooling fluid can be controlled in a desired manner to further control the cooling of the die surfaces 20 and 26.

In one embodiment, the hot stamped component 36 is a B-pillar for an automotive vehicle body. In one embodiment, the hot stamped component 36 is a rear rail for an automotive vehicle body. However, it should be appreciated that the hot forming system 100 could be employed to make a range of different automotive and non-automotive components, for example, including but not limited to, pillars, beams, bumpers, and rails. In one embodiment, the hot formed component 36 is cooled such that a microstructure having high ductile properties and reduced strength/hardness properties is formed within a first region of the hot formed component 36, while at the same time a martensite structure is formed in a second region of the hot formed component 36. That is, the second region of the hot formed component 36 remains substantially free of microstructure having high ductile properties and reduced strength/hardness properties. In one embodiment, the second region is prevented to be cooled in the standard hot stamp process/procedures in order meet the ductility requirements.

In one embodiment, the system 100 is configured to form two regions, one with martensite structure and the other with microstructure having high ductile properties and reduced hardness/tensile strength properties. However, it is contemplated that the number of regions with martensite and microstructure having high ductile properties may vary in the hot formed component 36. In one embodiment, additional “soft zones” within different regions of the hot formed component 36 may be formed in a single pass. In one embodiment, two or more non-contiguous “soft zones” may be formed in the hot formed component 36.

In one embodiment, the first die 12 may be a lower die. In another embodiment, the first die 12 may be an upper die. In one embodiment, the second die 14 may be an upper die. In another embodiment, the second die 14 may be a lower die.

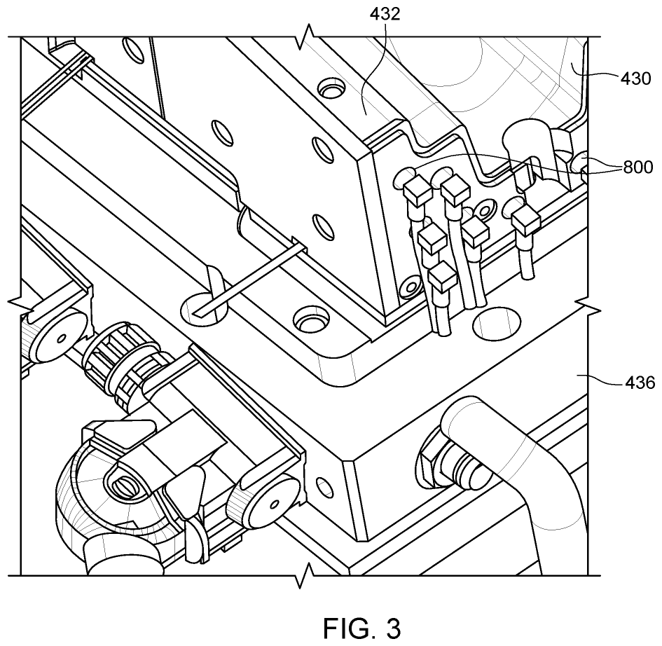

In one embodiment, as shown in FIGS. 2 and 3, the TTP form die structure 432 of each of the first and second dies 12 and 14 comprise one or more heaters/heating structures 800 therein that are configured to heat the corresponding die 12 or 14 during the hot forming procedures. In one embodiment, the heater/heating structure 800 includes one or more openings that are configured to receive the one or more heaters (e.g., cartridge heater) therethrough.

In one embodiment, during the hot forming, the blank 30 in contact with the water cooled die member (i.e., press hardened die structure) has a martensitic structure after forming, while the blank 30 in contact with the heater/heating structure (i.e., of the TTP form steel die structure 432) are heated to 450 to 525 degrees C. on surface. In one embodiment, the core temperature is in the range between 500 and 700 degrees C. and the surface temperature is in the range between 450 and 650 degrees C. During forming, this temperature prevents the blank 30 from converting to martensite structure. That is, heat from this temperature keeps the blank 30 above transition temperature. Therefore, the blank 30 in contact with the heater/heating structure has a Bainite structure. That is, the blank 30 in contact with the heater/heating structure (i.e., of the TTP form steel die structure 432) remains in a “soft” state. In one embodiment, the heater/heating structure of the die 12, 14 includes copper heater/heating structure.

In one embodiment, the TTP form steel die structure 432 includes heating structures/heaters 800. In one embodiment, the heaters 800 and the channels 450 for air cooling of the TTP form steel die structure 432 are configured to maintain the surface temperature range and/or the core temperature range of the TTP form steel die structure 432.

In one embodiment, the heater/heating structure 800 of the TTP form steel dies structure 432 of the die 12, 14 includes cartridge heaters and copper heater/heating sleeves. In another embodiment, the heater/heating structure 800 of the die 12, 14 includes only cartridge heaters. In another embodiment, the TTP form steel die structure 432 of the die 12, 14 includes a sleeve with the tubular cartridge heater. In one embodiment, the TTP form steel die structure 432 of the die 12, 14 includes pre-drilled holes that are configured to receive the sleeve with the tubular cartridge heater therein.

In one embodiment, referring to FIGS. 2-3 and 10, the TTP form steel die structure 432 is formed into the die 12, 14 by the method 1000. In one embodiment, the die structure 432 generally includes a workpiece from which the die 12, 14 is formed. In one embodiment, using the method 1000, the surface 430 of the die structure 432 is formed into the first die surface 20 of the first die 12 or the second die surface 26 of the second die 14. In one embodiment, the TTP form steel die structure 432 forms a part of the upper die 14 and includes a female cavity as shown in FIG. 2. In one embodiment, the TTP form steel die structure of the present patent application may form a part of the lower die 12 and includes a male cavity (not shown).

In one embodiment, the TTP form steel die structure 432 or die 12 includes a die member 18 that can be formed of a heat conducting material such as TTP form Steel, in particular, material grades such as W360, S600, S790 with final hardness between 56 and 58 HRC and that are marketed by Bohler-Uddeholm Corporation of Rolling Meadows, Ill. In one embodiment, the die member 18 includes the complex die surface 20, 430

In one embodiment, the TTP form steel die structure 432 or die 14 includes a die member 24 that can be formed of a heat conducting material such as TTP form Steel, in particular, material grades such as W360, S600, S790 with final hardness between 56 and 58 HRC and that are marketed by Bohler-Uddeholm Corporation of Rolling Meadows, Ill. In one embodiment, the die member 24 includes the complex die surface 26, 430. In one embodiment, the complex die surfaces 20 and 26 can cooperate to form the die cavity 132 therebetween.

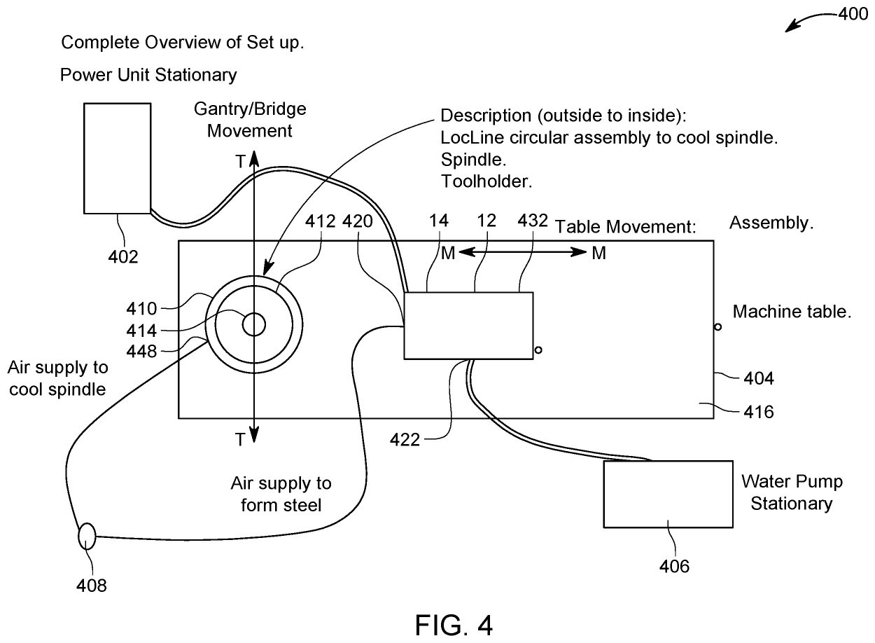

In one embodiment, the TTP form steel die structure 432 include any shape, size, or configuration as would be appreciated by one skilled in the art. In one embodiment, the TTP form steel upper die structure 432 includes a base, a pair of opposing walls and the surface 430 extending between the walls. In one embodiment, the pair of opposing walls include two opposed side walls and two opposed end walls. In one embodiment, a tool 410 of a system 400 (described in detail below, and referring to FIG. 4) is configured to machine predetermined edge surface profiles in regions of intersection of the surface 430 and the walls of the die structure 432.

As used herein, the term “die surface” refers to the portion of the exterior surface of a die that forms a hot formed component. Moreover, the term “complex die surface” as used herein means that the die surface has a three-dimensionally contoured shape.

As used herein, the terms “the surface of the die structure” refers to the portion of the exterior surface of the die structure that forms a die. In one embodiment, the surface of the die structure is machined to form the first die surface 20 of the first die 12 or the second die surface 26 of the second die 14.

FIG. 4 shows the system 400 for forming the TTP form steel die structure 432 of the die 12 or 14 of the hot forming system 100 in accordance with an embodiment of the present patent application. The system 400 includes a power unit 402, a machine table 404, a water source 406, an air supply source 408, a tool spindle air supply 418, a TTP form steel air supply 420, a TTP form steel water supply 422, and a tool 410 including a tool spindle 412 and a tool holder 414.

In one embodiment, the system 400 is any machining system that is configured to machine a predetermined surface profile on the surface 430 of the TTP form steel die structure 432. In one embodiment, the system 400 include any powered machine tools and/or equipment that are configured to machine a predetermined surface profile on the surface 430 of the TTP form steel die structure 432.

In one embodiment, the predetermined surface profile includes a three-dimensionally contoured shape. In one embodiment, the predetermined surface profile includes a two-dimensionally shape. In one embodiment, the predetermined surface profile includes a complex shape. In one embodiment, the surface of the die is configured to cooperate with a surface of another die having a predetermined surface profile to form a die cavity therebetween so as to receive a blank member therein and wherein the surfaces of the dies are configured to be on opposite sides of the blank member received in the die cavity to form a hot stamped component.

In one embodiment, the system 400 is a laser machining system. In one embodiment, the system 400 is a Computer Numerically Controlled (CNC) machining system. In one embodiment, the system 400 is a milling machine. In one embodiment, the system 400 is an end milling machine. In one embodiment, the system 400 is a Computer Numerically Controlled (CNC) milling machine. In one embodiment, the system 400 is a Computer Numerically Controlled (CNC) Controlled Multi-Axis Milling Machine. In one embodiment, the system 400 is a CNC Controlled three Axis Milling Machine. In another embodiment, the system 400 is a CNC Controlled five Axis Milling Machine.

In one embodiment, the system 400 is configured to facilitate interchange of one tool/tool spindle 412 with another tool/tool spindle. In one embodiment, the system 400 is configured to hold the tool/tool spindle 412 in a predetermined position during the machining procedures.

In one embodiment, the tool 410 includes a ¾ inch diameter cutting tool with four flute ball nose screw in head. In one embodiment, the tool 410 has 1500 rpm and a feed rate of 1650 millimeters (mm) per minute. In one embodiment, the tool 410 is a Mitsubishi P.N. IMX20-B4HV075M. In another embodiment, the tool 410 may include other tools. In one embodiment, the tool/extension holder 414 of the tool 410 has a ¾ inch diameter and is 5.1 inches in length. In one embodiment, the tool/extension holder 414 of the tool 410 includes a solid carbide extension. In one embodiment, the tool/extension holder 414 of the tool 410 is a Mitsubishi P. N. IMX20-U0750N2 56L51 C. In another embodiment, the tool/extension holder 414 of the tool 410 may include other tool holders. In one embodiment, the tool 410 is a 1992 Okuma MCV20A with a maximum rpm of 2000. In other embodiments, the rpm and feed rates may vary. For example, in one embodiment, higher rpm and feed rates may be used. In one embodiment, machine tools and tool/extension holders of other makes, models and types can be used.

In one embodiment, during the machining procedures, the machine table 404 is configured to be movable in the direction of an axis M-M. In one embodiment, the movement of the machine table 404 provided by a numerically controlled servomotor. In one embodiment, the die structure 432 is configured to be fixed by a clamping mechanism or a chuck device on the machine table 404 during the machining procedures. In one embodiment, during the machining procedures, the machine table 404 is configured to receive the die structure 432 on a surface 416 thereon.

In one embodiment, during the machining procedures, the tool 410 is configured to be movable in the direction of an axis T-T. In one embodiment, the movement of the tool 410 provided by a numerically controlled servomotor. In one embodiment, during the machining procedures, the tool spindle 412 is configured to be movable vertically along a vertical axis (e.g., perpendicular to the axis T-T and to the axis M-M) by a numerically controlled servomotor. In one embodiment, all three axis are configured to move simultaneously, individually, or any pair of axial movement as determined by CNC CAM produced program.

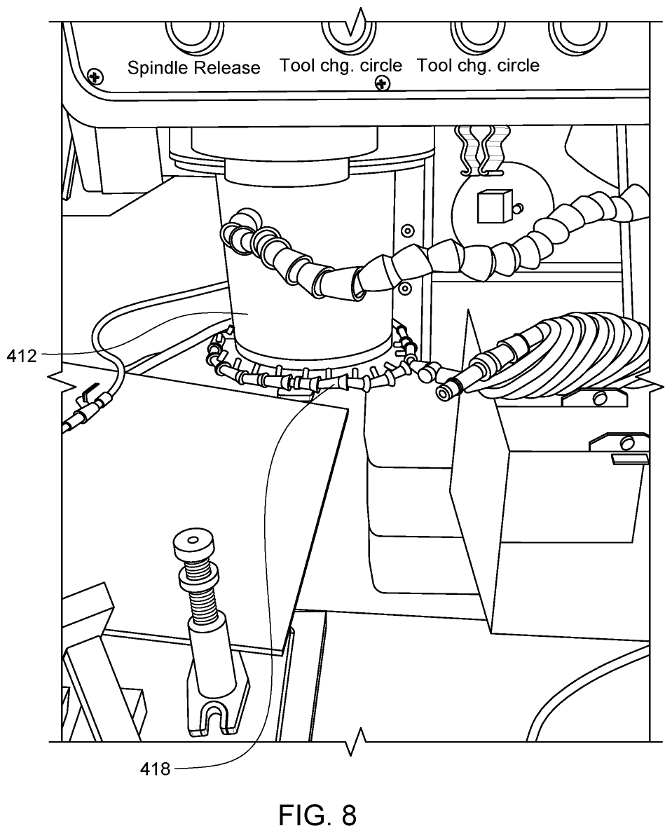

In one embodiment, during the machining procedures, the tool spindle 412 is configured to be cooled so as to eliminate any heat dissipation from the TTP form steel die structure 432 during machining up to the tool spindle 412. In one embodiment, the system 400 and the method 1000 of the present patent application are configured to prevent damage of the tool spindle 412 due to overheating. In one embodiment, as shown in FIG. 8, the system 400 includes air cooling ring or cooling structure (as will be clear from the discussions below) that is attached to nose of the tool spindle 412 so as to protect the tool spindle 412 from the excessive heat.

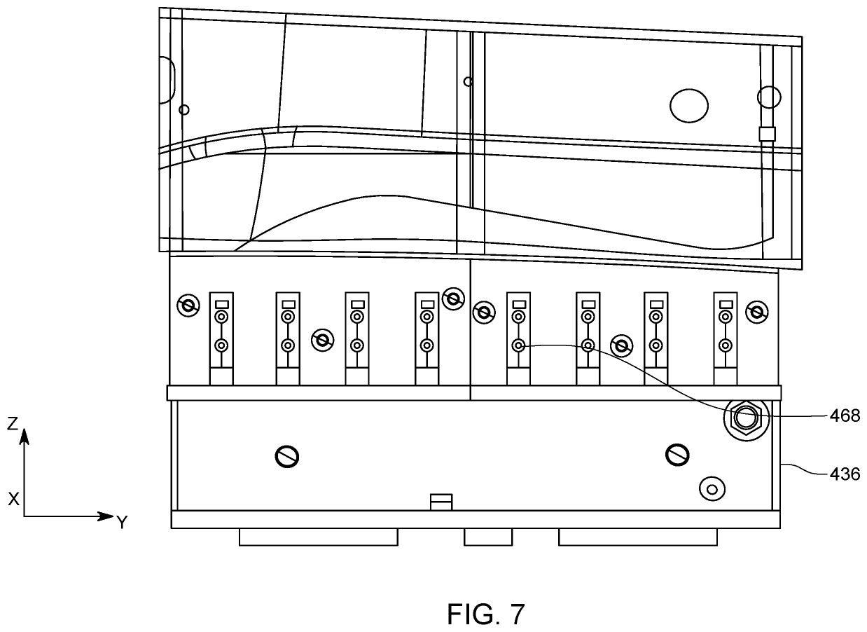

In one embodiment, the power unit/source 402 is a stationary unit. In one embodiment, the power source 402 is configured to provide power to the cartridge heaters only in 432, 12, 14 that are configured to heat the die structure 432, to provide power to various servomotors that are configured to control the machine table 404, the tool 410, the spindle 412, and/or to provide power to other components/sub-systems of the system 400. In one embodiment, the power source 402 is configured to be installed close to the machine or system 400 during machining. In one embodiment, as shown in FIG. 7, terminals 468 are used for power hook up.

In one embodiment, the heater/heating structure 800 that is used to heat and maintain the surface 430 of the TTP form steel die structure 432 to/at a temperature of 450° C. (i.e., during the machining procedures to form the die 12, 14) is also used to heat the TTP form steel die structure 432 of the die 12, 14 during the hot stamping or hot forming process. That is, the same heater/heating structure 800 is used both during the hot forming/hot stamping procedures and also during the forming of the TTP form steel die structure 432 of the die 12, 14. In one embodiment, the heater/heating structure 800 is disposed in the TTP form steel die structure 432 or die 12, 14.

In one embodiment, the heater/heating structure 800 that is disposed in the TTP form steel die structure 432 or die 12, 14 is also used to heat and maintain the core of the die structure 432 to/at a predetermined core temperature (i.e., during the machining procedures to form the die 12, 14).

In one embodiment, the airlines or channels 450 for air cooling (as shown in FIG. 11) that are used to control or maintain the surface 430 of the TTP form steel die structure 432 at the temperature in the range between 450° C. and 650° C. or within a predetermined surface temperature range (i.e., during the machining procedures to form the die 12, 14) are also used to cool the TTP form steel die structure 432 of the die 12, 14 (formed from the die structure 432) during the hot stamping or hot forming process. That is, the same airlines or channels 450 for air cooling are used both during the hot forming/hot stamping procedures and also during the forming of the TTP form steel die structure 432 of the die 12, 14. In one embodiment, the airlines or channels 450 for air cooling are disposed in the die structure 432 or die 12, 14. In one embodiment, the airlines or channels 450 for air cooling are configured to provide air as a coolant medium. In one embodiment, the air coolant supply/source 408 is a stationary unit. In one embodiment, the air coolant supply/source 408 is configured to provide air/coolant to cool the tool 410 (including its spindle 412), and to cool the TTP form steel die structure 432.

In one embodiment, the tool spindle air supply 418 is configured to supply air/coolant from the air coolant supply/source 408 to the tool 410 (including its tool spindle 412). In one embodiment, the air coolant supply/source 408 is configured to provide air/coolant to cool the tool 410 (including its tool spindle 412) so as to prevent damage of the tool spindle 412 due to overheating during the machining of the surface 430 of the TTP form steel die structure 432.

In one embodiment, the TTP form steel air supply 420 is configured to supply air/coolant from the air coolant supply/source 408 to the TTP form steel die structure 432. In one embodiment, the TTP form steel air supply 420 is configured to move along with the machine table 404.

In one embodiment, air coolant is configured to cool the TTP form steel die structure 432 when the surface temperature is very close to or at a predetermined threshold surface temperature. In one embodiment, air coolant is configured to cool the TTP form steel die structure 432 when the surface temperature falls outside a predetermined threshold surface temperature range. In one embodiment, when the elevated surface temperature of the TTP form steel die structure 432 (at which the machining of the TTP form steel die structure 432 is performed) is in the range of 450-500° C., the predetermined threshold surface temperature is 500° C. In one embodiment, the surface temperature is in the range between 450 and 650° C.

In one embodiment, air coolant is configured to cool the die structure 432 when the core temperature is very close to or at a predetermined threshold core temperature. In one embodiment, air coolant is configured to cool the die structure 432 when the core temperature falls outside a predetermined threshold core temperature range.

In one embodiment, the surface temperature of the TTP form steel die structure 432 is configured to control the transition phase of the blank/workpiece in the die cavity during the hot stamping operations. In one embodiment, the surface temperature of the die structure 432 is dependent on the core temperature of the die structure 432.

In one embodiment, the air coolant supply/source 408 is configured to provide coolant to cool the TTP form steel die structure 432 so as to control or maintain the temperature of the surface 430 of the die structure 432 at the temperature of 450° C. In one embodiment, the air coolant supply/source 408 is configured to be installed close to the machine or system during machining.

In one embodiment, the air coolant system including 408, 420 include an on and off valve that is activated (e.g., by a signal, or electronically) when the temperature of the surface 430 of the die structure 432 exceeds 500° C.

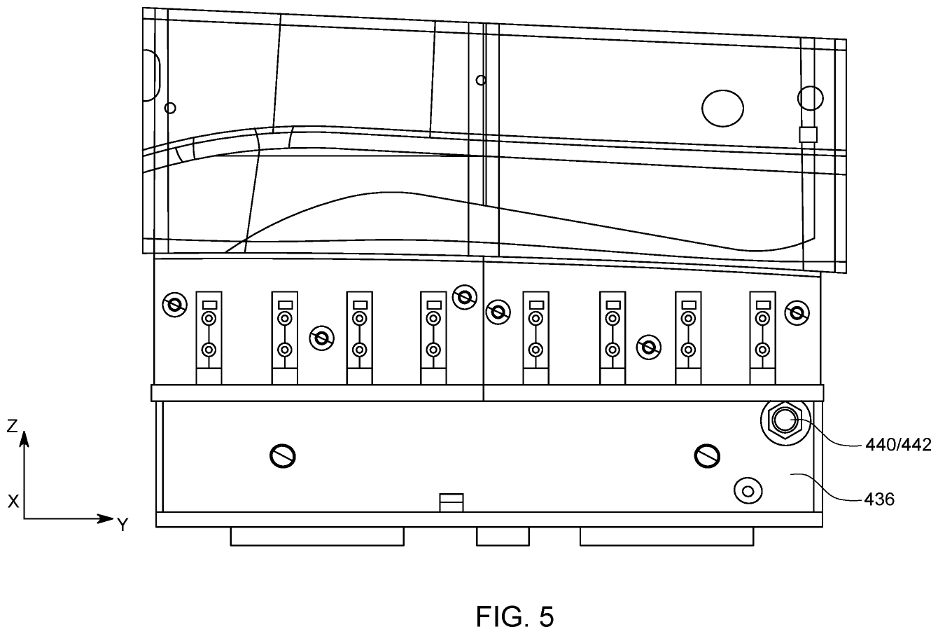

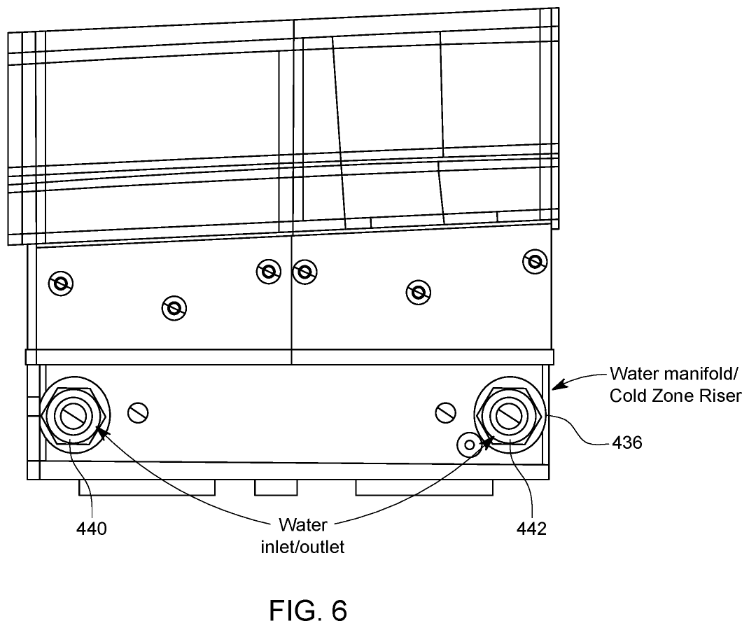

In one embodiment, water inlet 440/water outlet 442 of the system 400 of the present patent application is shown in FIG. 5. The purpose of water inlet 440/water outlet 442 is to allow water to be channeled up from cold zone riser 436 through sub-plate 438 so as to cool the cold zone riser 436. In one embodiment, the cold zone riser 436 includes A36 steel material. In one embodiment, the cold zone riser 436 may also be referred to as soft zone riser.

In one embodiment, the water source 406 is a stationary unit. In one embodiment, the water source 406 includes a water pump. In one embodiment, the water source 406 includes a water tank. In one embodiment, the system includes a permanent water hook up on two CNC mills/milling machines due to the water in the water tank heats up very quickly as the water is cycled through the cold zone riser 436 and back into the water tank. In one embodiment, the water coolant supply/source 406 is configured to be installed close to the machine or system during machining. In one embodiment, the water source 406 is configured to prevent system from overheating as the water source 406 acts a barrier between the TTP form steel die structure 432 and the main water supply manifold/cold zone riser 436.

In one embodiment, a CNC mills/milling machine includes two waterline hook ups (i.e., one inlet and one outlet). In one embodiment, water emanates from the main water tank, through the cold zone riser and back through to the main water tank.

In one embodiment, the coolant is configured to create a cooling barrier between the TTP form steel die structure 432 and the machine table 404. In one embodiment, water inlet 440 and water outlet 442 are hooked up to the water source 406. In one embodiment, the water/coolant is configured to be pumped through the water inlet port 440, cycled around the water manifold/cold zone riser 436 via waterlines and exit through the water outlet port 442 back into the water tank/source 406. This process is configured to create a cooling barrier between the TTP form steel die structure 432 and the machine table 404.

In one embodiment, temperature (i.e., surface and/or core) of the TTP form steel die structure 432 is configured to be monitored. In one embodiment, temperature (i.e., surface and/or core) of the TTP form steel die structure 432 is monitored, for example, by a sensor 916 (see FIG. 9). In one embodiment, the temperature (i.e., surface and/or core) of the TTP form steel die structure 432 is configured to be monitored, for example, by thermo couples 916 (see FIG. 11). In one embodiment, sensors or thermo couples 916 are disposed in or on the TTP form steel die structure 432. In one embodiment, temperature (i.e., surface and/or core) of the TTP form steel die structure 432 is configured to be monitored by sensor 916. In one embodiment, as shown in FIG. 11, the TTP form steel die structure 432 may include sensor 916c configured to measure the temperature of the core of the TTP form steel die structure 432 and sensor 916s configured to measure the temperature of the surface of the TTP form steel die structure 432. In one embodiment, the surface temperature of the TTP form steel die structure 432 is dependent on the core temperature of the TTP form steel die structure 432.

In one embodiment, initial toolpath of the tool 410 is monitored for safety. In one embodiment, initial toolpath of the tool 410 is monitored, for example, by a sensor. In one embodiment, initial toolpath of the tool 410 is monitored by sensor 916.

In one embodiment, the tool holder 414 is configured to have the tool 412 attached at a distal side thereof. In one embodiment, the tool 412 includes the tool spindle 412. In one embodiment, the tool holder 414 and the tool/tool spindle 412 are connected to each other using a quick release lock mechanism.

In one embodiment, temperature of both the spindle 412 and the tool holder 414 are monitored by, for example, a heat gun. In one embodiment, temperature of both the spindle 412 and the tool holder 414 are monitored by, for example, a sensor. In one embodiment, temperature of both the spindle 412 and the tool holder 414 are monitored by, for example, a thermo couple. In one embodiment, temperature of both the spindle 412 and the tool holder 414 are monitored by sensor 916.

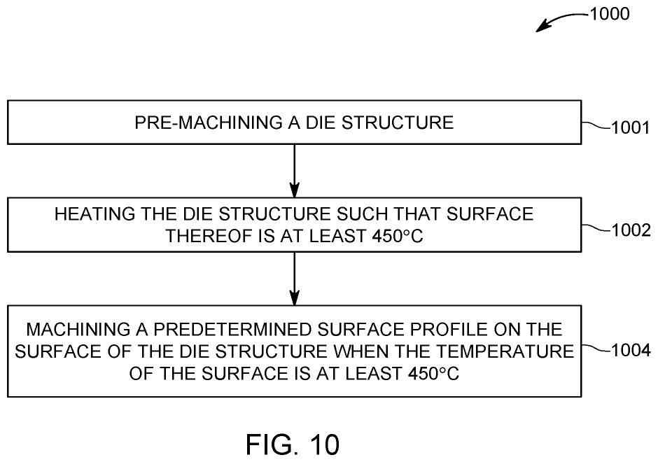

In one embodiment, the die structure 432 may be pre-machined by another system, known to one skilled in the art, before transferring the TTP form steel die structure 432 to the system 400 in which the surface 430 of the TTP form steel die structure 432 is machined at elevated temperatures. In one embodiment, the pre-machining procedure 1001 (as shown in FIG. 10) includes removing material from an initial/full die structure 432 (a solid block of metal). In one embodiment, the pre-machining includes rough cutting/machining. In one embodiment, material removal processes or traditional machining include procedures that mechanically cut away small chips of material using a sharp tool. In one embodiment, the system 400 is configured to perform the pre-machining procedures therein. In one embodiment, the system 400 is configured to perform fine tuning the surface profile of the pre-machined die structure 432. In one embodiment, the shape of the part before machining is approximately 1.5 millimeters (mm) larger than finished dimensions and produced prior to the heat treatment procedures.

In one embodiment, once the surface temperature of the TTP form steel die structure 432 reaches 450° C., then the machining procedures commence. In one embodiment, the machining procedures include machining the predetermined surface profile on the surface of the TTP form steel die structure 432 while the temperature of the surface is at least at or is maintained at least at 450° C. In one embodiment, the machining procedures includes milling the predetermined surface profile on the surface 430 of the TTP form steel die structure 432 while the temperature of the surface 430 is at least 450° C. In one embodiment, the machining procedures are configured to continue until the temperature of the surface of the TTP form steel die structure 432 is within a predetermined surface temperature range. In one embodiment, the surface temperature of the TTP form steel die structure 432 is continuously monitored during the machining procedures.

In one embodiment, once the core temperature of the TTP form steel die structure 432 reaches 500 to 700° C. and surface 450 to 650° C., then the machining procedures commence. In one embodiment, the machining procedures include machining a predetermined surface profile on the surface of the TTP form steel die structure 432 while the core temperature is the at least 500 degrees C. dependent upon OEM soft zone requirement. In one embodiment, the machining procedures are configured to continue until the core temperature of the TTP form steel die structure 432 is within a predetermined core temperature range. In one embodiment, the core temperature of the TTP form steel die structure 432 is continuously monitored during the machining procedures.

In one embodiment, if the surface temperature of the TTP form steel die structure 432 exceeds 500° C. (e.g., as measured by the heat gun or sensor 916 (as shown in FIG. 11)), the machining procedures are not stopped and air to the TTP form steel die structure 432 is activated. In one embodiment, the surface temperature of the TTP form steel die structure is monitored until the surface temperature of the TTP form steel die structure 432 reaches 450° C. In one embodiment, the air is switched off and the machining procedures are restarted when the surface temperature of the TTP form steel die structure 432 reaches 450° C.

In one embodiment, if the core temperature of the TTP form steel die structure 432 exceeds 500 to 700 degrees C. dependent upon OEM requirement and material red zone capabilities, (e.g., as measured by the sensor 916 (as shown in FIG. 11)), the machining procedures are stopped and air to the TTP form steel die structure 432 is activated. In one embodiment, the core temperature of the TTP form steel die structure 432 is monitored until the core temperature of the TTP form steel die structure 432 reaches 540° C. In one embodiment, the air is switched off and the machining procedures are continued when the core temperature of the TTP form steel die structure 432 reaches 500 to 700 degrees C. dependent upon OEM requirement and material red zone capabilities.

In one embodiment, temperatures of the tool holder 414 and the spindle 412 are monitored. For example, the temperatures of the tool holder and the spindle are monitored periodically (e.g., 10 minutes) with a heat gun, a thermo couple or a sensor. In one embodiment, if the temperatures of the tool holder 414 and the spindle 412 change/increase by 30° C. from their respective baseline temperature readings, cooling media/coolant to the tool holder 414 and the spindle 412 is activated and the temperatures of the tool holder 414 and the spindle 412 are monitored until the temperatures of the tool holder 414 and the spindle 412 reach their respective predetermined tool holder temperature and predetermined spindle temperature. In one embodiment, if the temperatures of the tool holder 414 and the spindle 412 change/increase by 30° C. from their respective baseline temperature readings, the method 1000 for forming the TTP form steel die structure 432 and its machining procedures is stopped.

In one embodiment, the method 1000 include performing a total of four scans. In one embodiment, the method 1000 includes a cold scan to confirm original designed data with calculated expansion factor of the TTP form steel die structure 432. In one embodiment, the method 1000 includes a hot scan when the TTP form steel die structure 432 is at temperature to confirm stock allowance (i.e., the amount of material left for finishing after rough cutting/machining had been completed). In one embodiment, the stock allowance is predetermined. In one embodiment, the method 1000 includes a second hot scan after final machining of the TTP form steel die structure 432 to confirm design intent dimensional requirements at temperature. In one embodiment, the method 1000 includes a second cold scan that provides design with actual expansion factor to design. In one embodiment, hot scans in the method 1000 are optional. In one embodiment, the hot scan generally refers to a scan/inspection of the TTP form steel die structure 432 performed to detect features of the TTP form steel die structure 432. In one embodiment, the hot scan may be performed to collect data about the TTP form steel die structure 432.

In one embodiment, on the CNC mill/milling machine, the surface 430 of the TTP form steel die structure 432 is heated up to 500° C. and the core of the TTP form steel is heated up to 570° C., milling of the die 432 is performed at these temperatures with zero stock allowance. In one embodiment, accurate representation of finished machine TTP form steel is determined by applying controlled heat to the TTP form steel die structure 432 to the production intent temperature.

In one embodiment, set point temperature of the TTP form steel die structure 432 is 540° C. In one embodiment, high set point temperature of the TTP form steel die structure 432 is 550° C., which is maximum temperature before the power of the system 400 is switched off. In one embodiment, the high set point temperature of the TTP form steel die structure 432 is in the range between 500 and 700° C. In one embodiment, the minimum temperature of the TTP form steel die structure 432 that is automatically set is at 530° C. due to the 10 degree nominal to maximum range. In one embodiment, these values are the same as what would be used in Hot Stamp Press in order to get the required surface temperature. In one embodiment, once the set point temperature is reached, the actual core temperature will be at 557° C. In one embodiment, the control stipulates the surface temperature is at 540 degrees C. In one embodiment, once the surface temperature is held, the first hot scan was performed.

In one embodiment, the method 1000 of the present patent application includes machining crumple zone TTP form steel at the elevated surface temperatures in the range of 450-500° C. In one embodiment, an accurate calculation model is obtained by the method 1000 of the present patent application. In one embodiment, the calculation model is configured to calculate volumetric expansion of the TTP form steel die structure 432 at the elevated surface temperatures in the range of 450-650° C., so that when the surface temperature of the TTP form steel die structure 432 reaches 450 to 650° C., the TTP form steel die structure 432 will expand to final design intent dimensions providing an acceptable final spot condition in order to meet property requirements. In one embodiment, the data gathered from this method 1000 is configured to provide the design team direction in obtaining the expansion factor for each product type.

In one embodiment, referring to FIG. 9, the system 400 includes a computer system 919 that comprises one or more physical processors 920 operatively connected with sensor 916, database 932, the tool 410, the water coolant system 406, 422, and the air coolant system 408, 418, and 420.

In one embodiment, the sensor 916 includes a transmitter for sending signals/information and a receiver for receiving the signals/information. In one embodiment, the sensor 916 is configured to communicate wirelessly with the computer system 919. As shown in FIG. 9, in one embodiment, the sensor 916 is configured to be operatively connected with the computer system 919 and/or one or more physical processors 920 of the computer system 919. In one embodiment, the sensor 916 is configured to communicate with the tool 410, water coolant system 406, 422, and air coolant system 408, 418, and 420. In one embodiment, the sensor 916 is in communication with the database 932. In one embodiment, the information related to the temperature of the surface 430 and/or the core of the die structure 432 may be obtained from the database 932 that is being updated in real-time by the sensor 916. In one embodiment, the information related to the temperature of the tool 410 may be obtained from the database 932 that is being updated in real-time by the sensor 916. In one embodiment, the information related to the position of the tool 410 may be obtained from the database 932 that is being updated in real-time by the sensor 916.

In one embodiment, the sensor 916 may include one or more sensors disposed in a plurality of locations in the system 400. In one embodiment, the sensor 916 is selected from the group consisting of heat gun, thermo couple, temperature sensor, and/or other sensors to monitor the temperature and/or other parameters of the system 400. In one scenario, a monitoring device may obtain information (e.g., based on information from the sensor 916), and provide information to computer system 919 (e.g., comprising server 920) over a network (e.g., network 950) for processing. In another scenario, upon obtaining the information, the monitoring device may process the obtained information, and provide processed information to the computer system 919 over a network (e.g., network 950). In yet another scenario, the monitoring device may automatically provide information (e.g., obtained or processed) to computer system 919 (e.g., comprising server 920).

In one embodiment, the system 400 may comprise server 920 (or multiple servers 920). In one embodiment, server 920 includes one or more physical/hardware processors 920. In one embodiment, database 932 is shown as a separate entity, but, in some embodiments, database 932 could be part of computer system 919. In one embodiment, the server 920 comprises temperature subsystem 912, system control subsystem 914 or other components or subsystems.

In one embodiment, the temperature subsystem 912 is configured to receive/obtain the temperature information of the die structure 432 from the sensor 916. In one embodiment, the temperature information includes the temperature of the surface 430 of the die structure 432. In one embodiment, the temperature information includes the temperature of the core of the die structure 432. In one embodiment, the temperature information includes the temperature of the tool 410. In some embodiments, the temperature subsystem 912 is configured to further process the received/obtained temperature information. In one embodiment, the temperature subsystem 912 comprises a signal feature extraction unit that is configured to extract the temperature features and/or other features from the signals, data or information provided by the sensor 916.

In one embodiment, the temperature subsystem 912 is configured to determine if the surface temperature of the die structure 432 falls within a predetermined surface temperature range to begin machining of the predetermined surface profile on the surface 430 of the die structure 432. In one embodiment, the temperature subsystem 912 is configured to determine if the surface temperature of the die structure 432 is at least 450° C. to begin machining of the predetermined surface profile on the surface 430 of the die structure 432.

In one embodiment, the temperature subsystem 912 is configured to determine if the core temperature of the die structure 432 falls within a predetermined core temperature range to begin machining of the predetermined surface profile on the surface 430 of the die structure 432. In one embodiment, the temperature subsystem 912 is configured to determine if the core temperature of the die structure 432 is at least between 500 and 700 degrees C. (e.g., dependent upon OEM requirements and material red hardness properties) to begin machining of the predetermined surface profile on the surface 430 of the die structure 432.

In one embodiment, based on input received from the temperature subsystem 912, the system control subsystem 914 is configured to control the tool 410, the water coolant system 406, 422, and/or the air coolant system 408, 418, and 420.

In one embodiment, when it is determined that the surface temperature is at least 450° C. and falls within the predetermined surface temperature range, the system control subsystem 914 is configured to control the tool 410 to machine of the predetermined surface profile on the surface 430 of the die structure 432.

In one embodiment, during the machining, if it is determined that the surface temperature is outside the predetermined surface temperature range, the system control subsystem 914 is configured to stop the tool 410. In one embodiment, the system control subsystem 914 is configured to operate the air coolant system 408, 418, and 420 so as to cool the die structure 432 and/or the tool 410 if it is determined that the surface temperature is outside the predetermined surface temperature range, and/or if the surface temperature of the die structure 432 is above 500° C.

In one embodiment, during the machining, if it is determined that the core temperature is outside the predetermined core temperature range, the system control subsystem 914 is configured to stop the tool 410. In one embodiment, the system control subsystem 914 is configured to operate the air coolant system 408, 418, and 420 so as to cool the die structure 432 and/or the tool 410 if it is determined that the surface temperature is outside the predetermined surface temperature range, if it is determined that the core temperature is outside the predetermined core temperature range, if the surface temperature of the die structure 432 is between 500 to 700 degrees C. (e.g., dependent upon OEM requirements and material red hardness properties) and/or if it is determined that the core temperature of the die structure 432 is above 700° C.

In one embodiment, the system control subsystem 914 is configured to also operate the water coolant system 406, 422 to form the coolant barrier between the die structure 432 and the machine table 404.

In one embodiment, a subsystem of the system 400 is configured to continuously obtain subsequent core and surface temperature information, for example, for each product type. As an example, the subsequent information may comprise additional information corresponding to a subsequent time (after a time corresponding to information that was used to machine the predetermine surface profile on the surface 430 of the die structure 432). The subsequent information may be utilized to further update or modify the ranges and thresholds for the core and the surface temperatures (e.g., new information may be used to dynamically update or modify the ranges and thresholds for the core and the surface temperatures), etc. In one embodiment, a subsystem of system 400 may be configured to determine the ranges and thresholds for the core and the surface temperatures and/or to control the system 400 to adjust its parameters in accordance with a recursively refined profile (e.g., refined through recursive application of profile refinement algorithms) based on previously collected or subsequent core and surface temperature information. In one embodiment, the previously collected or subsequent core and surface temperature information is configured to obtain the expansion factor for each product type.

In one embodiment, the system 400 and the method 1000 of the present patent application are configured to enable machining of the die structure at elevated temperatures. In one embodiment, air coolant system 408, 418, 420 of the system 400 is configured to enable machining of the die at the elevated temperatures.

In one embodiment, the various computers and subsystems illustrated in FIG. 9 may comprise one or more computing devices that are programmed to perform the functions described herein. The computing devices may include one or more electronic storages (e.g., database 932, or other electronic storages), one or more physical processors programmed with one or more computer program instructions, and/or other components. The computing devices may include communication lines or ports to enable the exchange of information with a network (e.g., network 950) or other computing platforms via wired or wireless techniques (e.g., Ethernet, fiber optics, coaxial cable, WiFi, Bluetooth, near field communication, or other communication technologies). The computing devices may include a plurality of hardware, software, and/or firmware components operating together to provide the functionality attributed herein to the servers. For example, the computing devices may be implemented by a cloud of computing platforms operating together as the computing devices.

The electronic storages may comprise non-transitory storage media that electronically stores information. The electronic storage media of the electronic storages may include one or both of system storage that is provided integrally (e.g., substantially non-removable) with the servers or removable storage that is removably connectable to the servers via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information received from the servers, information received from client computing platforms, or other information that enables the servers to function as described herein.

The processors may be programmed to provide information processing capabilities in the servers. As such, the processors may include one or more of a digital processor, an analog processor, or a digital circuit designed to process information, an analog circuit designed to process information, a state machine, and/or other mechanisms for electronically processing information. In some embodiments, the processors may include a plurality of processing units. These processing units may be physically located within the same device, or the processors may represent processing functionality of a plurality of devices operating in coordination. The processors may be programmed to execute computer program instructions to perform functions described herein of subsystems 912-914 or other subsystems. The processors may be programmed to execute computer program instructions by software; hardware; firmware; some combination of software, hardware, or firmware; and/or other mechanisms for configuring processing capabilities on the processors. In some embodiments, hardware processors may be interchangeably referred to as physical processors. In some embodiments, machine readable instructions may be interchangeably referred to as computer program instructions.

It should be appreciated that the description of the functionality provided by the different subsystems 912-914 described herein is for illustrative purposes, and is not intended to be limiting, as any of subsystems 912-914 may provide more or less functionality than is described. For example, one or more of subsystems 912-914 may be eliminated, and some or all of its functionality may be provided by other ones of subsystems 912-914. As another example, additional subsystems may be programmed to perform some or all of the functionality attributed herein to one of subsystems 912-914. It should be appreciated that the different subsystems 912-914 performing the operations illustrated in FIG. 9 may reside in a system with the sensor 916 and the tool 410, the water coolant system 406, 422, and the air coolant system 408, 418, and 420. In some embodiments, the different subsystems 912-914 performing the operations illustrated in FIG. 9 may reside in an independent monitoring device.

In one embodiment, the system 400 may include a user interface may be configured to provide an interface between the system 400 and a user through which the user can provide information to and receive information from system 400. This enables data, results, and/or instructions and any other communicable items, collectively referred to as “information,” to be communicated between the user and the system 400. Examples of interface devices suitable for inclusion in user interface include a keypad, buttons, switches, a keyboard, knobs, levers, a display screen, a touch screen, speakers, a microphone, an indicator light, an audible alarm, and a printer. In some embodiments, information may be provided to the user by the user interface in the form of auditory signals, visual signals, tactile signals, and/or other sensory signals. It is to be understood that other communication techniques, either hard-wired or wireless, are also contemplated herein as the user interface. For example, in some embodiments, the user interface may be integrated with a removable storage interface provided by the electronic storage 932. In this example, information is loaded into the system 400 from removable storage (e.g., a smart card, a flash drive, a removable disk, etc.) that enables the user(s) to customize the system 400. Other exemplary input devices and techniques adapted for use with the system 400 as user interface include, but are not limited to, an RS-232 port, RF link, an IR link, modem (telephone, cable, Ethernet, internet or other). In short, any technique for communicating information with system 400 is contemplated as the user interface.

In one embodiment, the system 400 may also include a communication interface that is configured to send input/control signals to the tool 410, the water coolant system 406, 422, and the air coolant system 408, 418, and 420 based on the determined temperature information through an appropriate wireless communication method (e.g., Wi-Fi, Bluetooth, internet, etc.). In one embodiment, the system 400 may include a recursive tuning subsystem that is configured to recursively tune its intelligent decision making subsystem using available data or information to provide better overall adjustment of and/or better overall control of the tool 410, the water coolant system 406, 422, and the air coolant system 408, 418, and 420. In one embodiment, intelligent decision making subsystem, communication interface and recursive tuning subsystem may be part of computer system 919 (comprising server 920).

In one embodiment, the automotive rear rails are made in the system and the method of the present patent application. In another embodiment, various other automotive components are made in the system and the method of the present patent application.

In one embodiment, the system 100 of the present patent application may be used to form products having tailored tempered properties (TTP). For example, such products may include regions of reduced hardness, reduced strength and/or high ductility/yield/elongation in products. In one embodiment, the system of the present patent application may be used to form vehicle body pillars, vehicle rockers, vehicle roof rails, vehicle bumpers and vehicle door intrusion beams. In another embodiment, the system of the present patent application may be used to form customer required hot stamp structural components. In one embodiment, the hot formed member or component may be referred to as a hot stamped member or a hot shaped member. For example, hot stamping allows for the forming of complex part geometries with the final product achieving ultra-high strength material properties.

Although the present patent application has been described in detail for the purpose of illustration, it is to be understood that such detail is solely for that purpose and that the present patent application is not limited to the disclosed embodiments, but, on the contrary, is intended to cover modifications and equivalent arrangements that are within the spirit and scope of the appended claims. In addition, it is to be understood that the present patent application contemplates that, to the extent possible, one or more features of any embodiment can be combined with one or more features of any other embodiment.

What is claimed is:

1. A method for forming a die, comprising:
heating a die structure such that a surface thereof is at least 450° C.; and
machining, by a machining system, a predetermined surface profile on the surface of the die structure while the temperature of the surface is at the at least 450° C. to form the die.

2. The method of claim 1, wherein the heating of the die structure includes heating the die structure using a cartridge heater disposed in the die structure.

3. The method of claim 1, further comprising cooling the die structure when a core temperature of the die structure is outside a predetermined core temperature range and/or when the temperature of the surface of the die structure is outside a predetermined surface temperature range.

4. The method of claim 3, wherein cooling the die structure includes cooling the die structure using channels disposed in the die structure for air cooling.

5. The method of claim 3, wherein the predetermined surface temperature range is between 450 to 550° C.

6. The method of claim 3, wherein the predetermined core temperature range is between 500 to 650° C.

7. The method of claim 1, wherein the machining system includes a tool holder configured to have a tool attached at a distal side thereof, and wherein the tool holder and tool are releasably connected to each other using a lock mechanism.

8. The method of claim 7, further comprising cooling the tool when a temperature of the tool is outside a predetermined tool temperature range.

9. The method of claim 8, wherein the tool includes a tool spindle, and wherein cooling the tool includes cooling the tool spindle.

10. The method of claim 1, wherein the machining system is selected from the group consisting of laser machining system, a Computer Numerically Controlled (CNC) machining system, a milling system, an end milling system, a Computer Numerically Controlled (CNC) milling system, a drilling system, a Computer Numerically Controlled (CNC) drilling system, a grinding system, and a Computer Numerically Controlled (CNC) grinding system.

11. The method of claim 7, further comprising stopping the tool of the machining system when a core temperature of the die structure is outside a predetermined core temperature range and/or when the temperature of the surface of the die structure is outside a predetermined surface temperature range.

12. The method of claim 1, wherein the die structure includes a die cavity for forming a part, wherein machining includes machining the surfaces of the die cavity so as to conform the shape of the die to the component when the die cavity is within a predetermined temperature range, and wherein the predetermined temperature range is between 450 to 550° C.

13. The method of claim 1, further comprising pre-machining the die structure prior to the heating procedure.

14. The method of claim 1, wherein the die structure is a Tailored Tempered Properties (TTP) form steel die structure.
